(19) United States
(12) Patent Application Publication
(10) Pub. No.: US 2009/0139648 A1
(43) Pub. Date: Jun. 4, 2009

(54) Film for Applying on Handrail of Conveyor

(76) Inventor: Hideki Nakanishi, Hyogo (JP)

Correspondence Address: BIRCH STEWART KOLASCH & BIRCH, PO BOX 747, FALLS CHURCH, VA, 22040-0747, US

(21) Appl. No.: 12/083,982

(22) PCT Filed: Oct. 20, 2006
(86) PCT No.: PCT/JP2006/320941

§ 371 Date: Apr. 23, 2008

(30) Foreign Application Priority Data
Oct. 26, 2005 (JP) 2005-311015

(51) Int. Cl. B32B 37/00; B32B 27/00; B32B 7/02

(52) U.S. Cl. 156/277; 428/500; 428/521; 428/215; 428/423.1; 428/41.8

(57) ABSTRACT

A film for applying on a handrail of a conveyor is prepared, which comprises a substrate film comprising a soft resin and a first sticky layer formed on a first surface of the substrate film and has a Young's modulus of 50 to 500 MPa and shows no yield point strength at the range of an elongation of not more than 100%. The film may have, for example, a 2% modulus of not less than 10 MPa and a strain at zero stress in a 15% elongation test of not more than 5%. The substrate film may comprise an olefinic resin and an elastic polymer. The first sticky layer may comprise at least a polyisobutylene. The film for applying on a handrail of a conveyor may comprise an adhesive layer comprising a soft adhesive resin and formed on a second surface of the substrate film and an ink receiving layer which is formed on the adhesive layer. The film for applying on a handrail of a conveyor has a high conformability to the changing shape of the handrail of the conveyor and an excellent removability.

### TECHNICAL FIELD

The present invention relates to a sticker-type film for applying on (or attaching to) a handrail (balustrade) of a conveyor (e.g., an escalator and an autowalk or a moving walk) to use the handrail as advertising media or the like.

### BACKGROUND ART

Conveyors (conveyors for transporting passengers) such as escalators or moving walks are installed in places crowded with people such as department stores and stations. Since many people take the conveyors, it has been suggested to use the handrails of the conveyors as advertising media. Pertaining to use a conveyor handrail as advertising media, a process for applying a film on which information is printed on a handrail has been suggested. Since the handrail circulates, interlocking with the conveyor, a film bearing advertising for applying on the handrail requires a flexibility that allows the film to conform to the changing shape of the handrail.

For example, a flexible film for applying on a handrail is disclosed in Japanese Patent Application Laid-Open Publication No. 537200/2002 (JP-2002-537200A, Patent Document 1). The film comprises a first film layer, a first layer of adhesive on the underside of the first film layer, a second film layer, and a second layer of adhesive bonding the underside of the second film layer to the top of the first film layer, has a width corresponding to a handrail and is elongate, and can be cut to fit a selected handrail. This document teaches a polyurethane as a material for the flexible film.

An adhesive sheet for a handrail of a conveyor is disclosed in Japanese Patent Application Laid-Open Publication No. 276975/2003 (JP-2003-276975A, Patent Document 2). The sheet comprises a synthetic resin film and an adhesive layer laminated on the synthetic resin film. The synthetic resin film has a strain at zero stress of not more than 4%, a 2% modulus of not more than 7 MPa, and no yield point. This document mentions that a material for the synthetic resin film includes a rubber and a thermoplastic elastomer and preferably includes a polyurethane resin such as a urethane rubber (or a polyurethane rubber) or urethane-series thermoplastic elastomer. In addition, the document teaches that an adhesive agent includes an acrylic, a urethane-series, a silicone-series, and a rubber (rubber-based) adhesive agent. An acrylic adhesive agent is described as a preferred one.

However, since these films comprising a polyurethane are stretched in stripping the films from the handrails, removing the films becomes difficult. Moreover, after applying the film comprising a polyurethane on a handrail of an escalator and the escalator is actuated, in the edges of the film on the handrail lips, wrinkles or creases are formed by the motion of the handrail at a curved part. Further, using an acrylic adhesive agent or the like as an adhesive agent hinders the removal of the film from the handrail, and the adhesive agent remains on the handrail in removing the film.

[Patent document 1] JP-2002-537200A (claim 1 and paragraph No. [0116])
[Patent document 2] JP-2003-276975A (claims 1 and 4, paragraph Nos. [0016], [0017], and [0029], and Examples)

### DISCLOSURE OF THE INVENTION

### Problems to be Solved by the Invention

It is therefore an object of the present invention to provide a film for applying on a handrail of a conveyor having a high conformability (or fitting property) to the changing shape of the handrail and an excellent removability (or stripability), a process for applying the film on a handrail of a conveyor, a use thereof, and a handrail of a conveyor on which the film is applied.

Another object of the present invention is to provide a film for applying on a handrail of a conveyor that is neither peeled nor wrinkled, in particular, is hardly creased by the motion of the handrail at a curved part on the edges on the handrail lips after the film is applied on the handrail, a process for applying the film on the handrail, a use of thereof, and a handrail of a conveyor on which the film is applied.

### Means to Solve the Problems

The inventor of the present invention made intensive studies to achieve the above objects and finally found that a film which comprising a substrate film having a sticky layer formed on a first surface of the substrate film and having a specific viscoelasticity, has a high conformability to the changing shape of a handrail of a conveyor and an excellent removability from the handrail. The present invention has achieved based on the above findings.

That is, the film of the present invention is a film for applying on a handrail of a conveyor, which comprises a substrate film comprising a soft resin and a first sticky layer formed on a first surface of the substrate film and has a Young's modulus of 50 to 500 MPa and no yield point strength in the range of an elongation of not more than 100%. The film for applying on a handrail of a conveyor may, for example, have a 2% modulus of not less than 10 MPa (e.g., about 10 to 1000 MPa) and show a strain at zero stress in a 15% elongation test of not more than 5% (e.g., about 0.01 to 5%). The substrate film preferably has a Young's modulus of 50 to 500 MPa and shows no yield point strength in a range of an elongation not more than 100%. Such a substrate film may comprise an olefinic resin (particularly a polypropylene-series resin) and an elastic polymer (or rubber-like or elastomeric polymer) (particularly a styrenic thermoplastic elastomer and/or a diene-series rubber). The proportion of the elastic polymer is about 1 to 300 parts by weight relative to 100 parts by weight of the olefinic resin. The first sticky layer may comprise at least one sticky polymer selected from the group consisting of an olefinic elastomer and an elastic polymer (particularly at least a polyisobutylene). The substrate film has a thickness of about 50 to 3000 μm and the first sticky layer has a thickness of about 0.1 to 100 μm. The film for applying on a handrail of a conveyor may comprise an adhesive layer comprising a soft adhesive resin and formed on a second surface of the substrate film and an ink receiving layer (or ink receptive layer) formed on the adhesive layer. The Young's modulus of the ink receiving layer and the Young's modulus of the adhesive layer relative to that of the substrate film may independently be about 0.5 to 3. The adhesive layer may comprise at least one adhesive resin selected from the group consisting of a urethane-series resin and a vinyl-series polymer (e.g., a polymer containing an acrylic unit). The ink receiving layer may, for example, comprise at least one selected from the group consisting of (A1) an aqueous polymer composition and (A2) a cationic vinyl polymer having a cross-linking group. The aqueous polymer composition (A1) may be a composition obtained by polymerizing a monomer composition containing a hydrophilic vinyl monomer and a copolymerizable vinyl monomer in an aqueous solution containing a saponified vinyl acetate-series polymer and at least one aqueous resin (water-soluble resin or water-dispersible resin) selected from the group consisting of an aqueous urethane resin and an aqueous polyester-series resin. The film for applying on a handrail of a conveyor may further comprise a protective layer formed on the ink receiving layer. The film for applying on a handrail of a conveyor may comprise a releasable separator (release paper) which is formed on the first sticky layer. The film is capable of recording an image by a recording system, e.g., an ink-jet recording system, an electrophotography recording system, a thermofusible transfer recording system, or a sublimation dye transfer recording system.

The present invention includes a process for applying the film on a handrail of a conveyor. The process comprises recording an image on the ink receiving layer of the film and applying the film on the handrail by attaching the first sticky layer to the handrail. Moreover, the present invention includes a use of the film for applying the film on a handrail of a conveyor by attaching the first sticky layer of the film having a recorded image, to the handrail of the conveyor. Further, the present invention includes a process for forming a protective layer. The process comprises recording an image on the ink receiving layer of the film for applying on a handrail of a conveyor, applying the film on a handrail of a conveyor by attaching the first sticky layer to the handrail, and forming a protective layer on the ink receiving layer by attaching a second sticky layer to the ink receiving layer.

In addition, the present invention includes a handrail of a conveyor on which the film for applying on a handrail is applied.

Incidentally, in the present description, the term “conveyor” denotes a strip-shaped transporting machine that transports passengers on a circulating belt (such as an escalator or a moving walk) and does not include a transporting machine that does not take passengers on a belt (e.g., an elevator).

### EFFECTS OF THE INVENTION

In the present invention, since the film for applying on a handrail comprises a substrate film having a sticky layer formed on a first surface thereof and has a specific viscoelasticity, the film has a high conformability to the changing shape of a handrail of a conveyor and an excellent removability from the handrail. Moreover, the film is neither peeled nor wrinkled, in particular, is hardly creased by the motion of the handrail at a curved part on the edges of the film on the handrail lips after applying the film on the handrail.

### DETAILED DESCRIPTION OF THE INVENTION

Film for Applying on Handrail of Conveyor]

The film of the present invention is a film for applying on a handrail of a conveyor and comprises at least a substrate film and a first sticky layer formed on a first surface of the substrate film. Moreover, the film may have an adhesive layer comprising a soft adhesive resin on a second surface of the substrate film and an ink receiving layer formed on the adhesive layer.

(Substrate Film)

The substrate film comprises a soft resin. The substrate film has a Young's modulus of about 50 to 500 MPa (for example, about 50 to 490 MPa), preferably about 100 to 480 MPa, and more preferably about 150 to 470 MPa (particularly about 200 to 460 MPa). Further, it is preferable that the substrate film shows no yield point strength until the elongation reaches 100% (preferably 120%, and more preferably 150%).

The elongation in the present invention is an index with respect to an increase in the length of a test piece which has been subjected to stretching in one direction (such as MD direction or TD direction) in a tensile test. The elongation is represented by the following formula:

[(L₁−L₀)/L₀]×100(%)

wherein L₀ is a length of a test piece before a tensile test and L₁ is a length of the test piece after the tensile test.

The yield point strength in the present invention is explained in the association with the tensile stress at yield described in JIS K 7161-1994, Part 1: General principles 4.3.1 or the like. The tensile stress at yield means an initial stress that keeps a strain increasing without a further increase of the stress. In the present invention, the term “a film shows no yield point strength” means that the film has the following physical properties based on a stress-strain curve: (1) a strain keeps increasing while a stress increases (which means that a film shows no tensile stress at yield) or (2) even after a tensile stress at yield is displayed, a stress does not start to decrease while a strain increases. In other words, the term “a film shows a yield point strength” means that the film shows a tensile stress at yield and a stress decreases while a strain increases.

The substrate film may have a 2% modulus of not less than 10 MPa (for example, about 10 to 1000 MPa), preferably about 10 to 100 MPa, and more preferably about 11 to 50 MPa (particularly about 12 to 30 MPa).

The strain at zero stress in a 15% elongation test of the substrate film may preferably be not more than 5% (e.g., about 0 to 5%), for example, may be about 0.01 to 5% (particularly, about 0.1 to 4%).

The soft resin having such properties may include, for example, an olefinic resin, a vinyl-series resin, an acrylic resin, a thermoplastic elastomer, a polyamide-series resin, an aliphatic polyester-series resin, and a urethane-series resin. These soft resins may be used singly or in combination. Moreover, even a hard resin may be used as a soft resin composition when the hard resin is mixed with a rubber component or a plasticizer (such as a mineral oil or a paraffin oil). In these soft resins, the preferred one includes a combination of an olefinic resin and an elastic polymer, or a soft olefinic resin. The particularly preferred one includes, for example, a combination of a polyethylene-series resin and/or a propylene-series resin and a hydrogenated diene-series elastomer or rubber component.

The olefinic resin may include a homo- or copolymer of an olefin. The olefin includes an α-C₂₋₁₆olefin, for example, ethylene, propylene, 1-butene, isobutene, 4-methyl-1-butene, 1-pentene, 3-methyl-1-pentene, 1-hexene, 1-octene, 1-nonene, 1-decene, 1-undecene, and 1-dodecene (preferably an α-C₂₋₁₀olefin, more preferably, an α-C₂₋₈olefin, and particularly an α-C₂₋₄olefin). These olefins may be used singly or in combination. In these olefins, ethylene, propylene, particularly, at least propylene is preferably contained as an olefin in the olefinic resin.

The olefinic resin may be a copolymer of an olefin and a copolymerizable monomer. The copolymerizable monomer may include, for example, a (meth)acrylate [e.g., a C₁₋₆alkyl (meth)acrylate such as ethyl (meth)acrylate], a vinyl ester (e.g., vinyl acetate and vinyl propionate), and a diene (e.g., butadiene and isoprene). The copolymerizable monomers may be used singly or in combination. The amount of the copolymerizable monomer relative to 100 parts by weight of the olefin may be selected from about 0 to 100 parts by weight, preferably about 0.1 to 50 parts by weight, and more preferably about 1 to 25 parts by weight.

The olefinic resin may include, for example, a polyethylene-series resin [e.g., a low-, middle- or high-density polyethylene, a linear low-density polyethylene, an ethylene-propylene copolymer, an ethylene-butene-1 copolymer, an ethylene-propylene-butene-1 copolymer, and an ethylene-(4-methylpentene-1) copolymer], a polypropylene-series resin (for example, a polypropylene, and a polypropylene content of not less than 80% by weight, e.g., a propylene-ethylene copolymer, a propylene-butene-1 copolymer, and a propylene-ethylene-butene-1 copolymer). The copolymer may include, for example, an ethylene-vinyl acetate copolymer, an ethylene-(meth)acrylic acid copolymer or an ionomer thereof, an ethylene-(meth)acrylate copolymer such as an ethylene-ethyl acrylate copolymer, and a maleic anhydride-grafted polypropylene.

The above-mentioned copolymer (a copolymer of olefins and a copolymer of an olefin and a copolymerizable monomer) includes, a random copolymer, a block copolymer, or a graft copolymer.

In these olefinic resins, in view of heat resistance, weather resistance, or the like, a polypropylene-series resin is preferred. The polypropylene-series resin is, in specific, a homopolymer of propylene or a propylene-α-olefin copolymer. The proportion of the propylene relative to the α-olefin [propylene/α-olefin] (weight ratio) is about 60/40 to 100/0, preferably about 70/30 to 99.9/0.1, and more preferably about 80/20 to 99.5/0.5 (particularly, about 90/10 to 99/1).

In the above-mentioned olefinic resins, the soft olefinic resin may include, for example, a low- or middle-density polyethylene, an ethylene-propylene copolymer, an ethylene-butene-1 copolymer, an ethylene-propylene-butene-1 copolymer, an ethylene-(4-methylpentene-1) copolymer, a propylene-butene-1 copolymer, a propylene-ethylene-butene-1 copolymer, an ethylene-vinyl acetate copolymer, an ethylene-(meth)acrylic acid copolymer or an ionomer thereof, an ethylene-ethyl acrylate copolymer, and a maleic anhydride-grafted polypropylene.

The elastic polymer may include a thermoplastic elastomer and a rubber component.

The thermoplastic elastomer may include, a styrenic thermoplastic elastomer (for example, an elastomer comprising a soft segment comprising a polybutadiene, a polyisoprene or a hydrogenated compound thereof, and a hard segment comprising a polystyrene); an olefinic thermoplastic elastomer (for example, an elastomer whose soft segment comprises an ethylene-propylene rubber or an ethylene-propylene-diene rubber and whose hard segment comprises a polyethylene or a polypropylene); a polyester-series thermoplastic elastomer (for example, an elastomer whose soft segment comprises an aliphatic polyether or polyester and whose hard segment comprises an alkylene terephthalate or an alkylene naphthalate); a polyurethane thermoplastic elastomer (for example, an elastomer whose soft segment comprises an aliphatic polyether or polyester and whose hard segment comprises a polyurethane unit obtained from a short chain glycol); and a polyamide-series thermoplastic elastomer (for example, an elastomer whose soft segment comprises an aliphatic polyether or polyester and whose hard segment comprises a polyamide unit). The molecular structure of the thermoplastic elastomer is not particularly limited to a specific one and may be, for example, a triblock copolymer, a star-block copolymer, a multi-block copolymer, a graft copolymer, and an ion cross-linked polymer. In these thermoplastic elastomers, a styrenic thermoplastic elastomer, particularly, a hydrogenated styrene-diene-series block copolymer (for example, a hydrogenated styrene-butadiene block copolymer) is preferred.

The rubber component may include, for example, a diene-series rubber [e.g., a polybutadiene (a low cis- or high cis-polybutadiene), a polyisoprene, a styrene-butadiene copolymer, a styrene-isoprene copolymer, a butadiene-acrylonitrile copolymer, an isobutylene-isoprene copolymer, a styrene-isobutylene-butadiene-series copolymer rubber, or a hydrogenated compound thereof]; an acrylic rubber [e.g., an amorphous copolymer containing an C₂₋₈alkyl acrylate (such as ethyl acrylate, butyl acrylate, or 2-ethylhexyl acrylate) as a main component (for example, a copolymer obtained by copolymerizing an alkyl acrylate, a vinyl monomer (such as methyl vinyl ketone), and an acrylic monomer (such as acrylic acid or acrylonitrile) and a copolymer obtained by copolymerizing the alkyl acrylate, the vinyl monomer, the acrylic monomer, and a cross-linking monomer (such as a monomer containing a carboxyl group or a monomer containing an epoxy group))]; an acrylic latex [e.g., a C₁₋₄alkyl methacrylate-C₂₋₈alkyl acrylate copolymer (for example, a methyl methacrylate-butyl acrylate copolymer and a methyl methacrylate-2-ethylhexyl acrylate copolymer)]; an ethylene-α-olefin copolymer [such as an ethylene-propylene rubber (EPR)]; an ethylene-α-olefin-polyene copolymer [such as an ethylene-propylene-diene rubber (EPDM)]; a urethane rubber; a silicone rubber; and a butyl rubber (or an isobutylene-isoprene rubber). In these rubber components, a diene-series rubber, particularly a hydrogenated diene-series rubber (for example, a hydrogenated styrene-butadiene copolymer) is preferred.

The proportion of the elastic polymer relative to 100 parts by weight of the olefinic resin (weight ratio) is about 1 to 300 parts by weight, preferably about 3 to 200 parts by weight, and more preferably about 5 to 100 parts by weight (particularly about 10 to 50 parts by weight).

The substrate film may be a drawn film. However, in order to conform to the changing shape of a handrail of a conveyor, the substrate film is preferably an undrawn film. Further, according to need, to the substrate film may be added a stabilizer (such as an antioxidant, a heat stabilizer, or an ultraviolet absorber), a lubricant, a pigment, or the like. Moreover, the film may be subjected to a corona discharge treatment, an under coating treatment, or the like, in order to fix the sticky layer on the film firmly.

The substrate film is capable for recording an image by a recording system. The recording system includes, e.g., an image-forming with a writing material (such as a pen with a oil-based ink or a water-based ink), an ink-jet recording system (e.g., an ink-jet system in which an ink droplet is jetted out of a nozzle toward a sheet), a hot-melt transfer recording system (or thermofusible transfer recording system), a sublimation dye transfer recording system, and an electrophotography recording system (such as a color copying machine or a color laser printer), besides various printing methods including an offset printing (planography), a gravure (photogravure), and a screen printing (silk screening). In these recording systems, an ink-jet recording system (particularly, an ink-jet recording system utilizing an oil-based ink or a solvent-based ink), a sublimation dye transfer recording system, or an electrophotography recording system is preferably used to form an image on the film. The image formed on the substrate film may be a sublimation image or a thermofusible-transferred image. The sublimation image includes, for example, an image formed by the sublimation dye transfer recording system with a sublimation coloring agent and an image formed by a recording system such as an ink-jet recording with a sublimation ink containing a sublimation coloring agent. The thermofusible-transferred image includes, for example, an image formed by a thermofusible transfer recording system with a thermofusible ink (an ink comprising a coloring agent and a thermofusible component such as a resin or a wax) and an image formed by an electrophotography recording system with a toner (a particle comprising a coloring agent, a magnetic particle, and a resin compound).

The thickness of the substrate film may be selected according to the applications and is usually about 50 to 3000 μm, preferably about 100 to 20000 μm, and more preferably about 200 to 1500 μm (particularly about 300 to 1000 μm).

(First Sticky Layer)

The first sticky layer is formed to attach the film of the present invention to a handrail tightly and comprises an adhesive component that allows the film to fix on handrail firmly.

The Young's modulus of the first sticky layer relative to that of the above-mentioned substrate film is about 0.5 to 3, preferably about 0.6 to 2, and more preferably about 0.7 to 1.5 (for example, about 0.7 to 1). It is preferable that the first sticky layer also shows no yield point strength in the range of an elongation of not more than 100% (preferably not more than 120%, and more preferably not more than 150%). When the tensile stress at yield is displayed, the tensile stress at yield of the adhesive layer relative to that of the above-mentioned substrate film is about 0.5 to 3, preferably about 0.6 to 2, and more preferably about 0.7 to 1.5 (for example, about 0.7 to 1). The 2% modulus and the strain at zero stress in a 15% elongation of the first sticky layer relative to those of the substrate film are independently about 0.5 to 3, preferably about 0.6 to 2, more preferably about 0.7 to 1.5 (for example, about 0.7 to 1).

The sticky component having such properties may include, for example, a rubber-based adhesive agent, an olefinic adhesive agent, a vinyl-series adhesive agent (such as a vinyl acetate-series adhesive agent, an ethylene-vinyl acetate copolymer-series adhesive agent, and a vinyl ether-series adhesive agent), an acrylic adhesive agent, a urethane-series adhesive agent, a polyester-series adhesive agent, a polyamide-series adhesive agent, a silicone-series adhesive agent, and a cellulose-series adhesive agent. These adhesive agents may be used singly or in combination.

In these adhesive agents, an adhesive agent comprising an olefinic elastomer and/or an elastic polymer is preferably used to remove (or strip) the film easily.

The olefinic elastomer may include, for example, a blended composition containing a soft component (such as an olefinic rubber) and a hard component (such as an olefinic resin) (e.g., a blended composition containing a polyethylene or a polypropylene and an ethylene-propylene rubber or an ethylene-propylene-diene rubber); a copolymer of an olefinic monomer and a vinyl monomer [e.g., an ethylene-C₁₋₄alkyl (meth)acrylate copolymer (such as an ethylene-ethyl (meth)acrylate copolymer or an ethylene-butyl (meth)acrylate copolymer), an ethylene-fatty acid vinyl ester copolymer such as an ethylene-vinyl acetate copolymer, a copolymer of ethylene and an epoxy group-containing monomer such as an ethylene-glycidyl methacrylate, and a propylene-(meth)acrylic acid copolymer]; an ethylene-α-olefin copolymer such as an ethylene-propylene rubber (EPR); an ethylene-α-olefin-diene-series copolymer such as an ethylene-propylene-diene rubber (EPDM); and a branched chain olefinic polymer (e.g., an olefinic polymer containing an isobutylene unit as a main unit such as a polyisobutylene). These olefinic elastomers may be used singly or in combination. In the olefinic elastomers, a branched olefinic polymer such as a polyisobutylene is preferred.

The elastic polymer may include, for example, a diene-series rubber [e.g., a polybutadiene (such as a low cis- or high cis-polybutadiene), a polyisoprene, a styrene-butadiene copolymer, a styrene-isoprene copolymer, a butadiene-acrylonitrile copolymer, an isobutylene-isoprene copolymer, and a styrene-isobutylene-butadiene-series copolymer rubber or a hydrogenated compound thereof]; an acrylic rubber [e.g., an amorphous copolymer containing a C₂₋₈alkylacrylate (such as ethyl acrylate, butyl acrylate, or 2-ethylhexyl acrylate) as a main component (for example, a copolymer obtained by copolymerizing an alkyl acrylate, a vinyl monomer (such as methyl vinyl ketone), and an acrylic monomer (such as acrylic acid or acrylonitrile) and a copolymer obtained by the alkyl acrylate, the vinyl monomer, the acrylic monomer, and a cross-linking monomer (such as a monomer containing a carboxyl group or a monomer containing an epoxy group))]; an acrylic latex [e.g., a C₁₋₄alkyl methacrylate-C₂₋₈alkyl acrylate copolymer (for example, a methyl methacrylate-butyl acrylate copolymer and a methyl methacrylate-2-ethylhexyl acrylate copolymer)]: an ethylene-α-olefin copolymer [such as an ethylene-propylene rubber (EPR)]; an ethylene-α-olefin-polyene copolymer [such as an ethylene-propylene-diene rubber (EPDM)]; a urethane rubber; a silicone rubber; and a butyl rubber. These elastic polymers may be used singly or in combination. In the elastic polymers, a diene-series rubber such as a polyisoprene or an isobutylene-isoprene copolymer or a butyl rubber is preferred.

In particular, an adhesive agent comprising at least a polyisobutylene hardly remains on a handrail of a conveyor after stripping the film, which makes the removal of the film easy.

The polyisobutylene is a polymer having a high molecular weight and has an elasticity like a rubber. The weight-average molecular weight of the polyisobutylene is, for example, about 1×10⁴ to 1000×10⁴, preferably about 10×10⁴ to 500×10⁴, and more preferably about 30×10⁴ to 300×10⁴ (particularly about 50×10⁴ to 200×10⁴).

The adhesive agent comprising at least a polyisobutylene may include, for example, a combination of a polyisobutylene and an elastic polymer (e.g., a combination of a polyisobutylene and a butyl rubber, a combination of a polyisobutylene and an isobutylene-isoprene copolymer, and a combination of a polyisobutylene and isoprene rubber), besides a polyisobutylene singly. In particular, the adhesive agent preferably contains a polyisobutylene having a weight-average molecular weight of about 50×10⁴ to 200×10⁴ as a main component (e.g., about 50 to 100% by weight, preferably about 70 to 99.9% by weight, and more preferably about 90 to 99% by weight).

Accordingly, in the present invention, the stretching property of the film is adjusted and a specific adhesive agent such as a polyisobutylene is used as a sticky layer for applying the film on a handrail of a conveyor. The adjustment of the stretching property and the use of the specific adhesive agent allow the film successfully to cope with both the conformability to the changing shape of a handrail and the adhesive strength of the sticky layer, which makes the film very suitable for applying on a handrail of a passenger conveyor. That is, the film for applying on a handrail of the present invention is neither wrinkled nor peeled, or the like, on the handrail of the conveyor which is moving, and the adhesive agent does not remain on the handrail even after stripping the film, which makes the removal of the film much easier.

The thickness of the first sticky layer is about 0.1 to 100 μm, preferably about 1 to 50 μm, and more preferably about 3 to 30 μm (particularly about 5 to 20 μm).

The sticky layer may be provided with a releasable separator (a release layer). The separator may be produced from a paper, a coating paper, and a synthetic paper or a plastic film or sheet, or the like. The separator may be usually subjected to a conventional releasing treatment to improve the releasability from the sticky layer.

The thickness of the separator is not particularly limited to a specific one. The thickness is about 10 to 3000 μm and preferably about 100 to 2000 μm.

(Adhesive Layer)

The film for applying on a handrail of a conveyor of the present invention may have an ink receiving layer for forming an image formed on a second surface of the substrate film (a reverse surface of a first surface of the substrate film, on which the first sticky layer is formed). The adhesive layer is provided between the substrate film and the ink receiving film to improve the bond of the substrate film and the ink receiving layer and comprises at least a soft adhesive resin.

The Young's modulus of the adhesive layer relative to that of the substrate film is about 0.5 to 3, preferably about 0.6 to 2, and more preferably 0.7 to 1.5 (for example, about 0.7 to 1). It is preferable that the adhesive layer also shows no yield point strength at the range of an elongation of not more than 100% (preferably not more than 120%, and more preferably not more than 150%). When the tensile stress at yield is displayed, the tensile stress at yield of the adhesive layer relative to that of the substrate film is about 0.5 to 3, preferably about 0.6 to 2, and more preferably about 0.7 to 1.5 (for example, about 0.7 to 1). The 2% modulus and the strain at zero stress in a 15% elongation test of the adhesive layer relative to those of substrate film are independently about 0.5 to 3, preferably about 0.6 to 2, and more preferably about 0.7 to 1.5 (for example, about 0.7 to 1).

In the present invention, such properties of the adhesive layer firmly bond the ink receiving layer and the film to each other, which prevents the ink receiving layer from breaking on a handrail moving and prevents the film from peeling or wrinkling.

The soft adhesive resin may include, for example, a thermoplastic resin [e.g., a vinyl resin (such as an acrylic resin or a vinyl acetate-series resin), a polyolefinic resin (e.g., a polyolefin modified with a carboxylic acid or carboxylic acid anhydride such as a maleic anhydride-grafted polypropylene or a (meth)acrylic acid-grafted polypropylene and an olefin-(meth)acrylic acid copolymer such as an ethylene-(meth)acrylic acid copolymer or a propylene-(meth)acrylic acid copolymer), a polyamide-series resin, a polyester-series resin, a thermoplastic polyurethane resin, a cellulose derivative, and a rubber-series adhesive (a rubber-modified styrenic resin such as an ABS resin or an MBS resin, a natural rubber, a styrene-butadiene rubber, a nitrile rubber, a chloroprene rubber, or a butyl rubber)], and a thermosetting resin (such as a two-component curable polyurethane resin).

In these soft adhesive resins, at least one selected from the group consisting of the urethane resin and the vinyl polymer may be preferably used.

The urethane resin may include, for example, a urethane polymer obtained by a reaction of a diisocyanate component and a diol component.

The diisocyanate component may include, for example, an aromatic diisocyanate (e.g., phenylene diisocyanate, tolylene diisocyanate, and diphenylmethane-4,4′-diisocyanate), an araliphatic diisocyanate (e.g., xylylene diisocyanate), an alicyclic diisocyanate (e.g., isophorone diisocyanate), and an aliphatic diisocyanate (e.g., 1,6-hexamethylene diisocyanate and lysine diisocyanate). The diisocyanate component may be an adduct and used in combination with a polyisocyanate component such as triphenylmethane triisocyanate according to need. The diisocyanate components may be used singly or in combination.

The diol component may include, for example, a polyester diol, a polyether diol, and a polycarbonate diol. The diol components may be used singly or in combination.

The polyester diol may be derived not only by a reaction of a diol and dicarboxylic acid or a reactive derivative thereof (such as a lower alkyl ester or an acid anhydride) but also from a lactone. The diol may include, for example, an aliphatic diol (e.g., a C₂₋₁₀alkanediol such as ethylene glycol, trimethylene glycol, propylene glycol, 1,3-butanediol, 1,4-butanediol, hexamethylene glycol, or neopentyl glycol and a polyoxyC₂₋₄alkylene glycol such as diethylene glycol or triethylene glycol), an alicyclic diol (e.g., 1,4-cyclohexanediol and 1,4-cyclohexanedimethanol), and an aromatic diol (such as bisphenol A or bisphenol S). The diols (diol components) may be used singly or in combination. If necessary, the diol (component) may be used in combination with a polyol such as trimethylolpropane or pentaerythritol.

The dicarboxylic acid may include, for example, an aliphatic dicarboxylic acid (e.g., a C₄₋₁₄aliphatic dicarboxylic acid such as adipic acid, suberic acid, azelaic acid, sebacic acid, or dodecanedicarboxylic acid), an alicyclic dicarboxylic acid (e.g., tetrahydrophthalic acid, tetrahydroisophthalic acid, and tetrahydroterephthalic acid), and an aromatic dicarboxylic acid (e.g., phthalic acid, terephthalic acid, isophthalic acid). These dicarboxylic acids may be used singly or in combination. The dicarboxylic acid may be used in combination with a polycarboxylic acid such as trimellitic acid or pyromellitic acid.

The lactones may include, for example, a C₃₋₁₂lactone such as butyrolactone, valerolactone, caprolactone, or laurolactone, and may be used singly or in combination.

In these urethane resins, the preferred one includes a polyether-based urethane resin obtained from a polyether diol (such as a polyoxytetramethylene glycol) as a diol component or a polyester-based urethane resin obtained from a polyester diol as a diol component. The polyester-based urethane resin includes, for example, a urethane resin obtained by a reaction of a polyester diol with a diisocyanate. The polyester diol used in the reaction includes, e.g., a polyester diol obtained from a reaction of a C₂₋₆alkanediol with a C₄₋₁₂aliphatic dicarboxylic acid such as adipic acid and a polyester diol derived from the above-mentioned lactone.

The urethane resin is preferably used in the form of an organic solvent solution, an aqueous solution, or an aqueous emulsion. The aqueous solution or aqueous emulsion of the urethane resin (an aqueous urethane resin) may be prepared by dissolving or emulsifying a urethane resin with an emulsifier or by introducing an ionic functional group (such as a free carboxyl group or a tertiary amino group) into a molecule of a urethane resin and dissolving or dispersing the urethane resin with an alkali or an acid. The urethane resin having a free carboxyl group or a tertiary amino group in the molecule comprises a urethane resin obtained by a reaction of a diisocyanate component with a diol component having a free carboxyl group or a tertiary amino (group) (e.g., a low molecular weight diol or a high molecular weight diol). Incidentally, the above-mentioned diol having a free carboxyl group (particularly a high molecular weight diol) is prepared by a reaction of a diol component with a polycarboxylic acid having not less than three carboxyl groups or an anhydride thereof (e.g., a tetrabasic acid anhydride such as pyromellitic anhydride), by a reaction of a diol component with a polycarboxylic acid having a sulfonic acid group (e.g., sulfoisophthalic acid), or by a process using dimethylolpropionic acid or N-methyldiethanolamine. The tertiary amino group may form a quaternary ammonium salt. The polyurethane resins may be used singly or in combination.

The vinyl polymer may include, for example, an acrylic polymer [e.g., a poly(meth)acrylic acid or a salt thereof, a methyl methacrylate-(meth)acrylic acid copolymer, an acrylic acid-vinyl alcohol copolymer, and a styrene-(meth)acrylate copolymer], a vinyl ether-series polymer (e.g., a polyvinyl C₁₋₆alkyl ether such as a polyvinyl methyl ether or a polyvinyl isobutyl ether and a C₁₋₆alkyl vinyl ether-maleic anhydride copolymer such as a methyl vinyl ether-maleic anhydride copolymer), a vinyl acetate-series polymer [e.g., a vinyl acetate-(meth)acrylic acid copolymer and a vinyl acetate-methyl acrylate copolymer], and a vinyl alcohol-series polymer (e.g., a polyvinyl alcohol, a modified polyvinyl alcohol, and an ethylene-vinyl alcohol copolymer). In these vinyl polymers, an acrylic polymer or the like is preferred. Theses vinyl polymers may be used singly or in combination.

In the above-mentioned adhesive resin, a polymer containing an acrylic unit (e.g., a styrene-(meth)acrylate copolymer and an acrylic urethane resin), in particular, an aqueous acrylic urethane resin is preferred. The aqueous acrylic urethane resin may include an aqueous urethane resin obtained by using an acrylic polyol component as a polyol component in the above-mentioned aqueous urethane resin. A polymer of a hydroxyalkyl (meth)acrylate, a copolymer of the above-mentioned hydroxyalkyl (meth)acrylate and a copolymerizable vinyl monomer, or the like, may be used as acrylic polyol. The weight-average molecular weight of the acrylic polyol is about 1000 to 100000, preferably about 5000 to 50000, and more preferably about 8000 to 30000.

The hydroxyalkyl (meth)acrylate may include, for example, a hydroxyC₂₋₆alkyl (meth)acrylate (e.g., 2-hydroxyethyl (meth)acrylate, 2-hydroxypropyl (meth)acrylate, 3-chloro-2-hydroxybutyl (meth)acrylate, 2-hydroxybutyl (meth)acrylate, 6-hydroxyhexyl (meth)acrylate, and 5,6-dihydroxyhexyl (meth)acrylate. These hydroxyalkyl (meth)acrylates may be used singly or in combination. The copolymerizable vinyl monomer includes, for example, an acrylic monomer (e.g., (meth)acrylic acid, (meth)acrylate, and acrylonitrile) and a vinyl monomer (e.g., vinyl acetate, maleic anhydride, and styrene).

The content of the acrylic polyol in the polyol component is not less than 5% by weight (for example, about 5 to 60% by weight), preferably about 7 to 50% by weight, and more preferably about 10 to 30% by weight. The polyol component may contain, e.g., the diol component exemplified in the paragraph of the urethane resin and a polyol component such as a rosin-modified polyol or a dimer diol, in addition to the acrylic polyol.

The rosin-modified polyol contained in the polyol component obtained by a reaction of a rosin with a diepoxy compound (e.g., 1.5 to 2.5 moles of the rosin relative to 1 mole of the diepoxy compound, particularly 2 moles of the rosin relative to 1 mole of the diepoxy compound) may be used as the rosin-modified polyol. The rosin may include, for example, a natural rosin (e.g., a gum rosin, a wood rosin, and a tall oil rosin) and a synthetic rosin (e.g., a refined (purified) rosin, a disproportionated rosin, and a hydrogenated rosin). The diepoxy compound may include, for example, an aliphatic glycidyl ether such as a (poly)ethylene glycol diglycidyl ether or a (poly)propylene glycol diglycidyl ether.

A dimer diol obtained by dimerizing an unsaturated fatty acid and reducing the resulting dimer acid may be used as the dimer diol. The unsaturated fatty acid constituting the dimer acid may include an unsaturated C₁₂₋₂₄fatty acid, e.g., oleic acid, linolic acid, and linolenic acid.

The contents of the rosin-modified polyol and dimer diol in the polyol component are independently about 1 to 40% by weight, preferably about 2 to 30% by weight, and more preferably about 5 to 20% by weight.

The adhesive layer may contain a conventional additives, for example, a dye fixing agent (e.g., a cationic compound such as a quaternary ammonium salt), a stabilizer (e.g., an antioxidant, an ultraviolet absorber, and a heat stabilizer), a dye or a pigment (e.g., a white pigment), an antistatic agent, a flame retardant, a lubricant, an antiblocking agent, a filler, a colorant, an antifoaming agent, an applicability improving agent, and a thickener.

The thickness of the adhesive layer is about 0.1 to 50 μm, preferably about 0.5 to 30 μm, and more preferably about 1 to 10 μm (particularly about 2 to 8 μm).

(Ink Receiving Layer)

The ink receiving layer of the film for applying on a handrail of a conveyor of the present invention may comprise a resin receptive to an ink (such as an ink for an ink-jet recording). The ink receiving layer may also comprise a soft nonhydrophilic or hydrophobic resin. The soft resin constituting the substrate film and the soft resin constituting the ink receiving layer may be the same or different. The ink receiving layer may be capable of recording an image by a recording system exemplified in the paragraph of the above-mentioned substrate film (for example, an ink-jet recording system, an electrophotography recording system, and a thermofusible transfer recording system or a sublimation dye transfer recording system). In particular, it is preferable that the ink receiving layer is provided when an image is recorded on the film by an ink-jet recording system. In view of convenience, an aqueous ink is widely used as an ink for an ink-jet recording. Accordingly, the ink receiving layer preferably comprises a soft hydrophilic polymer.

The Young's modulus of the ink receiving layer relative to that of the above-mentioned substrate film is about 0.5 to 3, preferably about 0.6 to 2, and more preferably about 0.7 to 1.5 (for example, about 0.7 to 1). Moreover, the ink receiving layer preferably shows no yield point strength at the range of an elongation of not more than 100% (preferably not more than 120%, and more preferably not more than 150%) as well as the substrate film. When the tensile stress at yield is displayed, the tensile stress at yield of the ink receiving layer relative to that of the substrate film is about 0.5 to 3, preferably about 0.6 to 2, and more preferably about 0.7 to 1.5 (for example, about 0.7 to 1). The 2% modulus and the strain at zero stress in a 15% elongation test of the ink receiving layer relative to those of the substrate film are independently about 0.5 to 3, preferably 0.6 to 2, more preferably 0.7 to 1.5 (for example, 0.7 to 1).

The soft hydrophilic polymer may include, for example, an aqueous urethane resin; an aqueous polyester-series resin; a vinyl-series polymer (e.g., a polyvinyl acetate, a polyvinyl alcohol, and an ethylene-vinyl acetate copolymer); a polyoxyalkylene glycol (e.g., a polyoxyC₂₋₄alkylene glycol such as a polyethylene glycol, a polypropylene glycol, an ethyleneoxide-propyleneoxide block copolymer, and a polytetramethylene ether glycol); an acrylic polymer [e.g., a poly(meth)acrylic acid or a salt thereof, an ethyl acrylate-(meth)acrylic acid copolymer, and an acrylic acid-vinyl alcohol copolymer]; a vinyl ether-series polymer (e.g., a polyvinyl alkyl ether such as a polyvinyl methyl ether or a polyvinyl isobutyl ether, and a C₁₋₆alkyl-vinyl ether-maleic anhydride copolymer); a hydrophilic natural polymer or a derivative thereof (e.g., alginic acid or a salt thereof, a gum arabic, a gelatine, a casein, and a dextrin); and a polymer containing a nitrogen atom (or a cationic polymer) or a salt thereof [e.g., a quaternary ammonium salt (such as a polyvinylbenzyltrimethylammonium chloride or a polydiallyldimethylammonium chloride), a polydimethylaminoethyl (meth)acrylate hydrochloride, a polyvinylpyridine, a polyethyleneimine, a polyacrylamide, and a polyvinylpyrrolidone]. The salt of the hydrophilic polymer (particularly, a salt of a carboxyl group or a sulfonic acid group) may include, an ammonium salt, an amine salt, a salt of an alkali metal such as sodium. These hydrophilic polymers may be used singly or in combination.

In the present invention, the soft hydrophilic polymer preferably comprises at least one selected from the group consisting of (A1) a polymer composition and (A2) a cationic vinyl polymer containing a cross-linking group. The polymer composition (A1) is obtained by polymerizing vinyl monomers [such as a monomer composition containing a hydrophilic vinyl monomer and a polymerizable vinyl monomer in the proportions (weight ratio) (the former relative to the latter) of about 100/0 to 60/40] in an aqueous solution containing a water-soluble resin or a water-dispersible resin (for example, at least one aqueous resin selected from the group consisting of an aqueous urethane resin and an aqueous polyester-series resin) and a dispersion or protective colloid (such as a saponified vinyl acetate-series polymer).

The aqueous urethane resin exemplified in the paragraph of the adhesive layer may be used as an aqueous urethane resin exemplified as the water-soluble resin or the water-dispersibie resin of the polymer composition (A1). A polyester-series resin obtained by the following process may be used as the aqueous polyester-series resin: the process comprises allowing a dicarboxylic acid component (e.g., an aromatic dicarboxylic acid such as terephthalic acid and an aliphatic dicarboxylic acid such as adipic acid) to react with a diol component (e.g., an alkanediol such as ethylene glycol or 1,4-butanediol) to give a polyester-series resin in which a hydrophilic group is introduced. The process for introducing a hydrophilic group includes, for example, the process using a dicarboxylic acid component having a sulfonic acid group or a carboxylic acid group as a dicarboxylic acid component. Such a dicarboxylic acid component includes 5-sodium sulfoisophthalic acid or a polycarboxylic acid having not less than three carboxylic acid groups.

The saponified vinyl acetate-series polymer may include, for example, a saponified polyvinyl acetate and a saponified copolymer of vinyl acetate and a vinyl monomer [e.g., an ethylene-vinyl acetate copolymer, a (meth)acrylic acid-vinyl acetate copolymer, a vinyl acetate-maleic anhydride copolymer, and a vinyl acetate-methyl (meth)acrylate]. The degree of saponification is, for example, about 75 to 100%, preferably about 80 to 100%, and more preferably about 90 to 100%. The average degree of polymerization may be about 300 to 10000, preferably about 500 to 5000, and more preferably about 1000 to 3000.

The hydrophilic vinyl monomer includes, for example, a monomer containing a carboxyl group which may be an acid anhydride group [e.g., (meth)acrylic, maleic acid, maleic anhydride], a monomer containing a hydroxyl group [e.g., hydroxyethyl (meth)acrylate, hydroxypropyl (meth)acrylate, and hydroxybutyl (meth)acrylate], a monomer containing an amide group [e.g., (meth)acrylamide and methyl (meth)acrylamide], and a monomer containing a sulfonic acid group (e.g., vinylsulfonic acid]. These hydrophilic vinyl monomers may be used singly or in combination.

The copolymerizable vinyl monomer may include, for example, an acrylic monomer [e.g., methyl (meth)acrylate and ethyl (meth)acrylate]; a cationic acrylic monomer [e.g., dimethylaminoethyl (meth)acrylamide, dimethylaminoethyl (meth)acrylate, and 4-(2-dimethylaminoethyl)styrene]; an aromatic vinyl monomer [e.g., styrene and vinyltoluene]; and a vinyl ester-series monomer [e.g., vinyl acetate and vinyl propionate]. In these monomers, a cationic monomer is preferably used to fix an ink on the film more firmly.

The proportion of the hydrophilic vinyl monomer relative to the copolymerizable vinyl monomer (weight ratio) (the former/the latter) is about 100/0 to 60/40, preferably about 99.9/0.1 to 70/30, and more preferably about 99/1 to 80/20.

The proportion of the saponified vinyl acetate-series polymer relative to 100 parts by weight of the aqueous urethane resin and/or the aqueous polyester-series resin is about 10 to 500 parts by weight and preferably about 20 to 300 parts by weight. The proportion of the vinyl monomer relative to 100 parts by weight of the aqueous urethane resin and/or the aqueous polyester-series resin is about 10 to 500 parts by weight and preferably about 20 to 300 parts by weight.

The following process may be exemplified as a process for producing the polymer composition (A1): a process comprising adding a radical polymerization initiator (such as a water-soluble polymerization initiator) and, if necessary, a small amount of an emulsifier to an aqueous dispersion containing an aqueous urethane resin and/or an aqueous polyester-series resin and a saponified vinyl acetate-series polymer, adding a vinyl monomer slowly to the dispersion with stirring at a temperature of about 70 to 80° C., and aging the resulting product for about 2 to 5 hours. The polymer composition (A1) obtained by this manner is preferably a grafted polymer composition.

The cationic vinyl polymer containing a cross-linking group (A2) may include a vinyl polymer obtained by polymerizing a cross-linking vinyl monomer and a cationic vinyl monomer. A monomer constituting the above-mentioned polymer may further include a hydrophilic vinyl monomer or a copolymerizable vinyl monomer, particularly a hydrophilic vinyl monomer.

Such a cross-linking vinyl monomer may include, a vinyl monomer containing an epoxy group [e.g., glycidyl (meth)acrylate and (meth)allyl glycidyl ether]; a monomer containing a methylol group [e.g., N-methylol(meth)acrylamide and N-methoxymethyl(meth)acrylamide]; and a monomer containing a hydrolytic condensatable group [e.g., a vinyltrialkoxysilane such as vinyltrimethoxysilane or vinyltriethoxysilane, a dialkoxyalkyl vinyl silane such as vinylmethoxydimethylsilane, avinyldialkoxyalkylsilane such as vinyldimethoxymethylsilane, an allyltrialkoxysilane such as allyltriethoxysilane, and a (meth)acryloxyalkylalkoxysilane such as β-(meth)acryloxyethyltrimethoxysilane, γ-(meth)acryloxypropyltriethoxysilane, γ-(meth)acryloxypropylmethyldimethoxysilane]. These cross-linking vinyl monomers may be used singly and in combination. In the cross-linking vinyl monomer, a monomer containing a hydrolytic condensatable group, particularly a monomer containing an alkoxysilyl group (for example, a C₁₋₄alkoxysilyl group such as methoxysilyl group or ethoxysilyl group) is preferred.

The cationic vinyl monomer may includes, for example, an acrylamide-series monomer containing a tertiary amino group [e.g., a dialkylaminoalkyl (meth)acrylamide such as dimethylaminoethyl (meth)acrylamide, diethylaminoethyl (meth)acrylamide, dimethylaminopropyl (meth) acrylamide or diethylaminopropyl (meth) acrylamide, and a salt thereof]; an acrylate-series monomer containing a tertiary amino group [e.g., a dialkylaminoalkyl such as (meth)acrylate such as dimethylaminoethyl (meth)acrylate, diethylaminoethyl (meth)acrylate, dimethylaminopropyl (meth)acrylate, or diethylaminopropyl (meth)acrylate and a salt thereof]; an aromatic vinyl monomer containing a tertiary amino group [e.g., an alkylaminoalkylstyrene 4-(2-dimethylaminoethyl)styrene, or 4-(2-dimethylaminopropyl)styrene, and a salt thereof]; and a heterocyclic monomer containing nitrogen atom [e.g., vinylpyridine, vinylimidazole, or vinylpyrrolidone, and a salt thereof]. The salt of the cationic vinyl monomer includes, for example, a salt of a hydrohalide acid (e.g., a hydrochloride and hydrobromate), a salt of a sulfuric acid or a salt of an alkylsulfuric acid (e.g., methylsulfate and ethylsulfate), a salt of an alkylsulfonic acid or a salt of an arylsulfonic acid, and a salt of a carboxylic acid (e.g., an acetic acid salt). Moreover, a quaternary ammonium-base may be produced by allowing a tertiary amino group to react with an alkylating agent (e.g., epichlorohydrin, methyl chloride, and benzyl chloride). These cationic vinyl monomers may be used singly or in combination. In the cationic vinyl monomer, the preferred one includes a diC₁₋₄alkylamino-C₂₋₃alkyl (meth) acrylamide or a diC₁₋₄alkylamino-C₂₋₃alkyl (meth)acrylate or a salt thereof.

The hydrophilic vinyl monomer includes, a monomer having a polyoxyalkylene group, for example, a mono(meth)acrylate of a di- to polyalkylene oxide (e.g., diethylene glycol mono(meth)acrylate, triethylene glycol mono(meth)acrylate, a polyethylene glycol mono(meth)acrylate, dipropylene glycol mono(meth)acrylate, and a mono(meth)acrylate of an ethylene oxide-propylene oxide copolymer), and glycerol mono(meth)acrylate, in addition to the hydrophilic vinyl monomer exemplified in the paragraph of the polymer composition (A1). These hydrophilic vinyl monomers may be used singly or in combination. In the hydrophilic vinyl monomer, the preferred one includes a polyC₂₋₄alkylene glycol mono(meth)acrylate.

The copolymerizable vinyl monomer exemplified in the paragraph of the polymer composition (A1) may be used as the copolymerizable vinyl monomer. These copolymerizable vinyl monomers may be used singly or in combination. In the copolymerizable vinyl monomer, the combination of a hard component such as a C₁₋₃alkyl (meth)acrylate (e.g., methyl methacrylate) or an aromatic vinyl monomer (e.g., styrene) and a soft component such as a C₂₋₁₀alkyl (meth)acrylate (e.g., butyl acrylate) is preferably used.

The content of the cross-linking vinyl monomer in the total vinyl monomer component is about 0.5 to 20% by weight and preferably about 2 to 10% by weight. The content of the cationic vinyl monomer in the total vinyl monomer component is about 1 to 40% by weight and preferably about 5 to 30% by weight. The content of the hydrophilic vinyl monomer in the total vinyl monomer component is about 0 to 50% by weight and preferably about 5 to 40% by weight. The content of the copolymerizable vinyl monomer in the total vinyl monomer component is about 10 to 90% by weight and preferably about 20 to 70% by weight.

The cationic vinyl polymer containing a cross-linking group (A2) preferably has a hydrophilic group as well as the polymer composition (A1). The cationic vinyl polymer (A2) is preferably used in the form of an aqueous solution or an aqueous dispersion, particularly, an aqueous emulsion.

It is preferable that the ink receiving layer further comprises (A3) a modified vinyl acetate-series polymer or a saponified thereof to fix an ink or to make the surface smooth. The vinyl acetate-series polymer or a saponified thereof exemplified in the paragraph of the above-mentioned polymer composition (A1) may be used as the vinyl acetate-series polymer or a saponified thereof. The modified vinyl acetate-series polymer includes a modified polymer obtained by modifying the above-mentioned vinyl acetate-series polymer or a saponified thereof with at least one selected from a polyoxyalkylene unit, an acetoacetyl group, a carboxyl group, an acid anhydride group, an amino group, and others or a polymer containing the above-mentioned group (for example, a polymer obtained from a monomer having the above-mentioned group).

The proportion of the modified vinyl acetate-series polymer or the saponified thereof (A3) relative to 100 parts by weight of the total amount of the polymer composition (A1) and the cationic vinyl polymer containing a cross-linking group (A2) is about 0 to 300 parts by weight, preferably about 5 to 100 parts by weight, and more preferably about 10 to 50 parts by weight.

The ink receiving layer may comprise other hydrophilic polymers [for example, a cellulose derivative (e.g., a cellulose ether such as methyl cellulose, ethyl cellulose, hydroxyethyl cellulose, hydroxypropyl cellulose, or carboxymethyl cellulose and a cellulose ester such as cellulose acetate or cellulose acetate butylate)] or a water-insoluble polymer. The ink receiving layer may comprise a conventional additive as exemplified by the additives in the above-mentioned adhesive layer.

The ink receiving layer may contain a pigment component such as a white pigment to improve the sharpness of a printed image. Such a pigment component may be contained in the substrate film, the adhesive layer, or the sticky layer.

The white pigment may include, for example, a titanium-series (titanium-containing) white pigment [e.g., a titanium oxide (a titanium white)], a zinc-series (zinc-containing) white pigment (e.g., a zinc oxide, and a zinc sulfide), a composite white pigment (e.g., a lithopone), and an extender [e.g., magnesium silicate, magnesium oxide, calcium carbonate, barium sulfate, an aluminum-series (aluminum-containing) extender (e.g., an alumina, aluminum hydroxide, and aluminum silicate), a silica, a mica, and a bentonite]. These white pigments may be used singly or in combination. In the white pigments, the titanium-series white pigment, particularly the titanium oxide, is preferred.

The crystal morphology or configuration of the titanium oxide may be an anatase-type (or mode). However, a rutile-type (or mode) is preferred, since the rutile-type (or mode) has an excellent masking property due to the large refractive index.

The average (mean) particle size of the white pigment is preferably not more than 3 μm, for example, about 0.01 to 3 μm, preferably about 0.05 to 2 μm (e.g., about 0.05 to 1 μm), and more preferably about 0.1 to 1 μm (e.g., about 0.1 to 0.5 μm).

The proportion of the white pigment relative to 100 parts by weight of the resin constituting the ink receiving layer is about 1 to 30 parts by weight, preferably about 5 to 20 parts by weight, and more preferably about 10 to 15 parts by weight.

The thickness of the ink receiving layer is about 1 to 100 μm, preferably about 3 to 50 μm, and more preferably about 5 to 30 μm (particularly about 10 to 20 μm).

The ratio of the thickness of the ink receiving layer relative to the thickness of the adhesive layer (the ink receiving layer/the adhesive layer) is about 1/1 to 10/1, preferably about 2/1 to 8/1, and more preferably about 3/1 to 6/1.

(Protective Layer and Second Sticky Layer)

The film for applying on a handrail of a conveyer of the present invention may further comprise a protective layer on the ink receiving layer. The protective layer protects a surface of the ink receiving layer, which improve the weather resistance of the film.

The preferred protective layer includes a resin layer which is transparent and has excellent mechanical properties. Such a protective layer includes a resin layer (resin film) comprising, for example, a polyolefinic resin (e.g., a polypropylene and a polyethylene), a cellulose derivative (e.g., acetyl cellulose), an aliphatic polyester-series resin, and a thermoplastic polyurethane resin. In the resins, a polyolefinic resin or a thermoplastic polyurethane resin is preferred. The thickness of the protective layer is about 1 to 1000 μm, preferably about 10 to 500 μm, and more preferably about 30 to 300 μm (particularly about 50 to 200 μm).

The film for applying on a handrail of a conveyor may have a second sticky layer formed between the protective layer and the ink receiving layer. The second sticky layer includes, e.g., the adhesive agent exemplified in the paragraph of the first sticky layer and the soft adhesive resin exemplified in the paragraph of the adhesive layer. An adhesive agent comprising at least a polyisobutylene, a urethane resin, a vinyl resin, or the like, may preferably be used as the second sticky layer as well as in the first sticky layer or in the adhesive layer.

The thickness of the second sticky layer is about 0.1 to 100 μm, preferably about 1 to 50 μm, and more preferably about 3 to 30 μm (particularly about 5 to 20 μm).

[Production Process of Film for Applying on Handrail of Conveyor]

The film for applying on handrail of conveyor of the present invention may be produced by forming the first sticky layer on a first surface of the substrate film. The first sticky layer may be formed by applying a coating agent for the sticky layer comprising the above-mentioned component on a first surface of the substrate film and drying the coating agent. If necessary, a separator may be applied on the first sticky layer. The coating agent may be in the form of a solution (coating solution) which contains the coating agent dissolved in an organic solvent (e.g., an aromatic hydrocarbon such as toluene or xylene). The concentration of the sticky component in the coating solution is, for example, about 1 to 50% by weight, preferably about 3 to 30% by weight, and more preferably about 5 to 20% by weight. Further, the coating agent may be applied by a conventional manner, for example, roller coating, air knife coating, blade coating, rod coating, bar coating, comma coating, and graver coating. The coated layer can be formed by drying the coating agent at a temperature of about 50 to 150° C. (preferably, about 80 to 120° C.) for about 10 seconds to 10 minutes (particularly about 30 seconds to 5 minutes).

Moreover, the film of the present invention may have an ink receiving layer. The ink receiving layer may be formed on the adhesive layer which has formed on a second surface of the substrate film. That is, the adhesive layer and the ink absorbing layer may be formed by applying a coating agent for the adhesive layer comprising the above-mentioned component on a second surface of the substrate film, drying the applied coating agent, and applying a coating agent for an ink receiving layer comprising the above-mentioned component on the obtained adhesive layer, or the like. The resin component may be practically used in the form of an aqueous solution or an emulsion. The solvent of the aqueous solution or the emulsion may be water alone or an aqueous solution containing a hydrophilic organic solvent such as an alcohol according to need. The process for applying the coating agent is the same as the process for applying the first sticky layer.

Further, the film of the present invention may have a protective layer. The protective layer may have a second sticky layer formed by the same manner as forming the first sticky layer on the substrate film. The process for forming the protective layer on the ink receiving layer comprises laminating the second sticky layer on the ink receiving layer. As long as recording an image on the ink receiving layer is finished, the protective layer may be laminated on the ink receiving layer at any time. Prior to, with, or after applying the film of the present invention on a handrail, the protective layer may be laminated on the ink receiving layer on which an image has been recorded.

[Properties and Use of Film for Applying on a Handrail of a Conveyor]

The film for applying on a handrail of a conveyor of the present invention is capable of recording an image by various recording systems (such as an electrophotography recording system, a thermofusible transfer system, or a sublimation dye transfer recording system). In particular, an ink-jet recording system, which jets a droplet of an ink (particularly an aqueous ink) to record an image, is easy and practical to record an image on the film.

The film for applying on a handrail of a conveyor of the present invention is a film that comprises a substrate film comprising a soft resin and at least a first sticky layer formed on a first surface of the substrate film, has a Young's modulus of 50 to 500 MPa, and shows no yield point strength at the range of an elongation of not more than 100%.

In specific, the film of the present invention has a Young's modulus of about 50 to 500 MPa (for example, about 50 to 490 MPa), preferably about 100 to 480 MPa, and more preferably about 150 to 470 MPa (particularly about 200 to 460 MPa). The tensile strength of the film is not more than about 30 MPa (for example, about 1 to 30 MPa), preferably about 3 to 25 MPa, and more preferably about 5 to 23 MPa (particularly about 10 to 23 MPa). Further, it is preferable that the film shows no yield point strength at the range of an elongation of not more than 100% (preferably not more than 120%, and more preferably not more than about 150%).

When the film shows a tensile stress at yield, the tensile stress at yield is, for example, not more than about 30 MPa (for example, about 0.1 to 30 MPa), preferably not more than about 10 MPa (for example, about 0.3 to 10 MPa), more preferably not more than about 8 MPa (for example, about 0.5 to 8 MPa), and particularly not more than about 7 MPa (for example, about 1 to 7 MPa). In addition, the degree of elongation (the elongation) is about 200 to 3000%, preferably about 300 to 2000%, and more preferably about 500 to 1500%.

Incidentally, in the present invention, in each layer of the film, such properties is ensured by using the resin or the rubber components mentioned above without using a plasticizer.

Since the film for applying on a handrail of a conveyor of the present invention has these properties, the film shows a flexibility and a plastic deformation. Once the film is deformed by stretching (or drawing), the film maintains the deformed shape even after relaxing the film. That is, the film has a moderate stretching property and maintains the elongation caused by stretching, unlike a rubber, which stretches and contracts. Accordingly, since the film of the present invention has a high conformability to the changing shape of a handrail of a conveyor, which bends at a curved part, the film is firmly attached to the handrail and the edges of the film on the handrail lips neither wrinkles nor crimples even (in running) at the curved part.

Moreover, the film of the present invention may have a 2% modulus of about not less than 10 MPa (for example, about 10 to 1000 MPa), preferably about 10 to 100 MPa, and more preferably about 11 to 50 MPa (particularly about 12 to 30 MPa). A film for applying on a handrail of a conveyor having an excessively small 2% modulus is excessively stretchy, which makes it difficult to strip the film from the handrail of the conveyor. On the other hand, a film for applying on a handrail of a conveyor having an excessively large 2% modulus has a lower conformability to the changing shape of the handrail.

In addition, the strain at zero stress in a 15% elongation test of the film for applying on a handrail of a conveyor of the present invention is preferably not more than about 5% (for example, about 0 to 5%) and may be, for example, about 0.01 to 5% (particularly about 0.1 to 4%). The strain at zero stress in a 15% elongation test of the film is a strain obtained by stretching the film as a sample in one direction to the elongation of 15% and relaxing the film in a reversal stretching direction until the stress becomes zero. The strain when the stress becomes zero again is measured as a strain at zero stress. A substrate film having an excessively large strain at zero stress in a 15% elongation test has a high conformability to the changing shape of the handrail.

The handrail of the conveyor, particularly, a typical escalator (for example, OTIS escalator 506NCE) has a handrail having a uniform thickness and comprising a top part that is a surface of the balustrade, side parts, and bottom parts that are located in the downside of the top part. During the escalator is running, at a rounded part (or a curved part), the outer diameter (the diameter of the semicircular arc described by the top part of the handrail) is about 840 mm, and the difference of between the outer diameter and the inner diameter (the diameter of the semicircular arc described by the bottom part of the handrail) is 40. In such a case, a shrinking degree of the inner circumference (the circumference with respect to the bottom part) relative to the outer circumference (the circumference with respect to the top part) is about 5% in a single side part and, in total, a shrinking degree is about 10%. That is, for applying the film of the present invention on a handrail, it is necessary that the film be kept stretching to an elongation of not less than 10%, and it is also necessary that the film on the handrail shrink by the initial length. Accordingly, in the present invention, the strain at zero stress in a 15% elongation test is preferably within 5%.

In the present invention, the film has a 2% modulus and a strain at zero stress in 15% elongation test within the above-mentioned ranges, which not only improves the conformability to the changing shape of a handrail of a conveyor but also makes removing the film easy during the replacement of a film.

Moreover, the shape of the film of the present invention is a shape corresponding to the shape of a handrail and is usually a tape shaped form (a long sheet form or a slim rectangular form). In view of forming an image on the sheet or feeding the sheet in a recording device (a printer), a separator preferably protrudes from at least one side of the sheet whose form is a rectangular form or the like. Accordingly, the end in at least one side of the substrate film is not covered with the separator to prevent the separator from peeling off while feeding the sheet in the printer. More specifically, the film having a side in which the substrate film is longer than the separator or protrudes from the separator, is fed into the printer, putting the side in the feeding or traveling direction, so that a problem in printing such as paper jam or the like is prevented. Accordingly, the separator preferably protrudes from the substrate film in at least one side which is toward to the feeding direction of a printer. To handle the sheet as the film for applying on a handrail of conveyor more easily, the sheet may have two sides opposite to each other in which the separator protrudes from the substrate film, two sides next to each other in which the separator protrudes from the substrate film, or all sides (four sides) in which the separator protrudes from the substrate film.

The width of the separator protruding from a side of the sheet may be about 0.3 to 20 mm, for example, about 0.5 to 10 mm, and preferably about 1 to 5 mm.

Further, for smooth feed of the film for applying on a handrail of a conveyor into the printer, the peel strength of the separator from the first sticky layer may be not less than 16 mN/25 mm (for example, 16 to 100 mN/25 mm), preferably not less than 18 mN/25 mm (for example, 18 to 50 mN/25 mm), and more preferably not less than 20 mN/25 mm (for example, 20 to 40 mN/25 mm).

The process of applying the film of the present invention may include, for example, the process for applying the film comprising recording an image on the film and applying the film on a handrail of a conveyor by attaching the first pressure-sensitive layer to the handrail. Concretely, after an image or a letter is recorded on the substrate film or the ink receiving layer by an ink-jet recording system or the like, the separator is removed from the first sticky layer to expose the first sticky layer. Then the film is applied on the handrail by attaching the exposed first sticky layer to the handrail. Further, since the film has the above-mentioned properties, the film can be attached to the handrail without forming creases, and the image on the film on the handrail is not distorted.

Moreover, the applying process of the film of the present invention may comprises recording an image on the film, applying the film on the handrail of the conveyor by attaching the first sticky layer on the handrail, and forming the protective layer on the film by attaching a second sticky layer to the film. In particular, when an image or a letter is recorded on the ink receiving layer by an ink-jet recording system after forming the ink receiving layer on the film, the protective layer may preferably be formed on the ink receiving layer to protect the recorded image. The protective layer may be formed on the ink receiving layer with or after applying the film on the handrail.

The film for applying on a handrail of a conveyor of the present invention has a high conformability to the changing shape of the handrail, and a recorded image on the film is not distorted even at a curved part. Moreover, since the film has an excellent weather resistance or heat-resistance, the film is suitable for use outside or under severe conditions.

### INDUSTRIAL APPLICABILITY

The film for applying on a handrail of a conveyor of the present invention is advantageous as a film for applying on a handrail (balustrade) of a conveyor to use the handrail as advertising media or the like, which forms a rounded part or curves (bends) while the conveyor is traveling (working). The handrail (balustrade) includes, for example, a handrail of an escalator and an autowalk or a moving walk way (moving walk). In particular, since the film of the present invention also has an excellent removability, the film is beneficial to an escalator or the like which is repeatedly used as advertising media by replacing a film bearing advertising whenever a set period of time ends.

### EXAMPLES

Hereinafter, the following examples are intended to describe this invention in further detail and should by no means be interpreted as defining the scope of the invention. Incidentally, unless otherwise indicated, the term “part” is used herein as “part by weight”. Moreover, the components used in Examples and Comparative Examples are as follows. In addition, each of properties of the films obtained in Examples and Comparative Examples was evaluated by the following methods.

[Component]

(Substrate Film)
PP containing a hydrogenated SBR: a polypropylene containing a hydrogenated styrene-butadiene copolymer rubber (SBR) in amount of 50% by weight (brand name “Dynasoft” manufactured by Nichigo Shoji Co.
PET: a polyethylene terephthalate (brand name “HS74” manufactured by Teijin DuPont Films Japan Ltd.)
CPP: an oriented polypropylene film comprising a polypropylene as a main raw material (brand name “Tohcello CP” manufactured by Tohcello Co., Ltd.)
PO: a film comprising a polyolefin as a main raw material (brand name “Emasoft3C matte white” manufactured by Okamoto Inc.)

(Adhesive Layer)
Styrene-acrylate copolymer: brand name “Polysol” manufactured by Showa high polymer Co., Ltd.
Aqueous acrylic urethane resin: brand name “NEOSTICKER 400W” manufactured by Nicca Chemical Co., Ltd.

(Ink Receiving Layer)
(A1) Polyester-series graft copolymer: brand name “NS-310X” manufactured by Takamatu oil & fat Co., Ltd.
(A2-1) Cationic vinyl polymer containing a cross-linking group: brand name “AQ-903” manufactured by Daicel Chemical Industries, Ltd. (A2-2) Cationic vinyl polymer containing a cross-linking group: brand name “ASi-784” manufactured by Daicel Chemical Industries, Ltd. Modified polyvinyl alcohol: brand name “Ecomaty WO320” manufactured by Nippon Synthetic Chemical Industries Co., Ltd.

(Sticky Layer)
Polyisobutylene: brand name “Vistanex MML-100” manufactured by Exxon Chemical Company (weight-average molecular weight of 1,000,000)

(Separator)
Paper having a silicone release layer on a single side thereof: brand name “KA7W white V13” manufactured by Lintec Corporation

(Protective Layer)
Protective film: a film obtained by coating a thermoplastic polyurethane resin film (brand name “Esmer-URS” manufactured by Nippon Matai Co., Ltd., thickness of 100 μm) with a polyisobutylene (brand name “Vistanex MML-100” manufactured by Exxon Chemical Company) to give a dry thickness of the polyisobutylene of 15 μm.

[Young's Modulus and 2% Modulus]

In accordance with JIS K 7161, the Young's modulus (in the machine direction (MD) of a sheet) and 2% modulus of the film for applying on a handrail of conveyor (without a separator) were measured.

[Strain at Zero Stress in 15% Elongation Test]

Under an atmosphere of 23° C., a film having a crosswise direction length of 25 mm and a longitudinal gripping distance of 100 mm was stretched in the longitudinal direction at a speed of 300 mm/minute. Right after the elongation reached 15%, the film was relaxed to the initial gripping distance by returning the grip parts at the same speed (stress reversal). The stresses and strains in the stress reversal were plotted on a graph having the stress as the longitudinal axis and strain as the abscissa axis to draw a hysteresis loop (curve). Based on the hysterisis loop, the strain displayed when a stress became zero in a stress reversal was defined as the strain at zero stress in a 15% elongation test.

[Conformability to Changing Shape of Handrail Belt]

A film was applied on a handrail of an escalator, and the escalator was actuated for 8 hours. Then, the appearance of the attached film was observed based on the following criteria.
A: Edges of the attached film on the handrail lips have neither wrinkles nor peelings.
B: Edges of the attached film on the handrail lips have wrinkles but no peelings.
C: Edges of the attached film on the handrail lips have wrinkles and peelings.

[Removability of Film]

A film was applied on a handrail of an escalator, and the escalator was actuated for a definite period of time. Then the film was stripped to evaluate the removability of the film by the following criteria.
A: Film slightly stretches and is easy to remove.
B: Film greatly stretches and is difficult to remove.

### Examples 1 to 2 and Comparative Examples 1 to 2

Ten parts of a polyisobutylene were dissolved in 90 parts of toluene to prepare a solution having a concentration of 10% by weight of the polyisobutylene. The solution was applied on a first surface of a substrate film shown in Table 1, so that a first sticky layer had a thickness of 15 μm after drying. Then the film was dried at 100° C. for 2 minutes to form the first sticky layer, and the release side of a separator was laminated on the surface of the sticky layer. The adhesive component shown in Table 1 was applied on a second surface of the substrate film, so that the obtained film had the thickness of the adhesive layer of 5 μm after drying. Then a composition for an ink receiving layer shown in Table 1 was applied on the adhesive layer, so that the obtained film (sticky film or adhesive film) had the thickness of the ink receiving layer of 10 μm after drying. Further, a protective film was laminated on the ink receiving layer of the film to prepare a film for applying on a handrail of a conveyor. The evaluation results of the obtained films are shown in Table 1. Incidentally, these films showed no tensile stress at yield until the films broke.

Moreover, after images were printed on the ink receiving layers of the sticky films by an ink-jet plotter (manufactured by Mimaki Engineering Co., Ltd., JV-4) with an aqueous ink, each of the sticky films was applied on a handrail of an escalator, and each of the protective films was further applied on the sticky films. Then the conformabilities to the changing shape of the handrail and removabilitities of the obtained films were evaluated. The results are shown in Table 1.

### Examples 3

Using the same manner as in Example 1, a film (sticky film) having a sticky layer and an adhesive layer was prepared. The sticky film had no ink receiving layer. Further, a protective film was laminated on the adhesive layer to prepare a film for applying on a handrail of a conveyor. The evaluation results of the obtained film are shown Table 1. Incidentally, the film showed no tensile stress at yield until the film broke.

Moreover, after an image was printed on the adhesive layer of the sticky film by a color laser copier (manufactured by Canon Inc., CLC1100), the sticky film was applied on a handrail of an escalator. A protective film was further laminated on the film, and the conformability to the changing shape of the handrail and the removabilitity of the obtained film were evaluated. The results are shown in Table 1.

### Example 4 and Comparative Example 3

Ten parts of a polyisobutylene were dissolved in 90 parts of toluene to prepare a solution having a concentration of 10% by weight of the polyisobutylene. The solution was applied on a first surface of a substrate film shown in Table 1, so that a first sticky layer had a thickness of 15 μm after drying. Then the film was dried at 100° C. for 2 minutes to form the first sticky layer, and the release side of a separator was laminated on the surface of the sticky layer to prepare a film for applying on a handrail of a conveyor. The evaluation results of the obtained films are shown in Table 1. Incidentally, these films showed no tensile stress at yield until the films broke.

Further, after images were printed on the surfaces of the substrate films of the films by an ink-jet plotter (manufactured Mimaki Engineering Co., Ltd. JV-3) with a solvent ink, the films were independently applied on a handrail of an escalator. The conformabilities to the changing shape of the handrail belt and removabilities of the films were evaluated. The results are shown in Table 1.

[Table 1]

TABLE 1

| | | | | | | Comparative | | |
|---|---|---|---|---|---|---|---|---|
| | | Examples | | | | Examples | | |
| | | 1 | 2 | 3 | 4 | 1 | 2 | 3 |
| Kinds and | PP containing a hydrogenated SBR | 65 | 65 | 65 | 65 | — | — | — |
| thickness (μm) of | PET | — | — | — | — | — | 50 | — |
| substrate | CPP | — | — | — | — | 50 | — | — |
| | PO | — | — | — | — | — | — | 100 |
| Kinds and | Styrene-acrylate copolymer | — | 5 | — | — | — | — | — |
| thickness (μm) of | Aqueous acrylic urethane resin | 5 | — | 5 | — | 5 | 5 | — |
| the adhesive | | | | | | | | |
| layer | | | | | | | | |
| Formulation of | (A1) Graft polymer | 30 | 30 | — | — | 30 | 30 | — |
| ink receiving | (A2-1) Vinyl polymer | 20 | 20 | — | — | 20 | 20 | — |
| layer (part) | (A2-2) Vinyl polymer | 20 | 20 | — | — | 20 | 20 | — |
| | Modified polyvinyl alcohol | 30 | 30 | — | — | 30 | 30 | — |
| | Thickness of ink receiving layer (μm) | 10 | 10 | — | — | 10 | 10 | — |
| | Thickness of sticky layer (μm) | 15 | 15 | 15 | 15 | 15 | 15 | 15 |
| | Thickness of protective film (μm) | 115 | 115 | 115 | — | 115 | 115 | — |
| Performances | Young's modulus in MD direction (MPa) | 450 | 450 | 450 | 420 | 800 | 4500 | 580 |
| | 2% modulus (MPa) | 15 | 15 | 15 | 14 | 700 | 240 | 7 |
| | Strain at zero stress in 15% elongation test (%) | 3 | 3 | 4 | 4 | — | — | 6 |
| | Conformability to changing shape of handrail belt | A | A | A | A | C | C | B |
| | Removability of film | A | A | A | A | A | A | B |

As apparent from the results in Table 1, since the films in the Examples have a Young's modulus of 50 to 500 MPa, a 2% modulus of not less than 10 MPa, and a strain at zero stress in a 15% elongation test of not more than 5%, the films still have the high conformabilities to the changing shape of the handrail of the escalator and the high removabilities after traveling the escalators. On the other hand, the films in Comparative Examples 1 to 3 have wrinkles and peelings when the handrails bend at curved parts followed by the straight line parts. In addition, the film in Comparative Example 3 has a low removability.

1. A film for applying on a handrail of a conveyor, which comprises a substrate film comprising a soft resin and a first sticky layer formed on a first surface of the substrate film, has a Young's modulus of 50 to 500 MPa, and shows no yield point strength in a range of an elongation of not more than 100%.

2. A film for applying on a handrail of a conveyor according to claim 1, which has a 2% modulus of not less than 10 MPa and a strain at a stress of 0 in a 15% elongation test of not more than 5%.

3. A film for applying on a handrail of a conveyor according to claim 1, which has a 2% modulus of 10 to 1000 MPa and a strain at a stress of 0 in a 15% elongation test of 0.01 to 5%.

4. A film for applying on a handrail of a conveyor according to claim 1, wherein the substrate film has a Young's modulus of 50 to 500 MPa and shows no yield point strength in a range of an elongation of not more than 100%.

5. A film for applying on a handrail of a conveyor according to claim 1, wherein the substrate film comprises an olefinic resin and an elastic polymer.

6. A film for applying on a handrail of a conveyor according to claim 1, wherein the substrate film comprises at least one selected from the group consisting of a polypropylene-series resin, a styrenic thermoplastic elastomer, and a diene-series rubber.

7. A film for applying on a handrail of a conveyor according to claim 5, wherein the proportion of the elastic polymer is 1 to 300 parts by weight relative to 100 parts by weight of the olefinic resin.

8. A film for applying on a handrail of a conveyor according to claim 1, wherein the first sticky layer comprises at least one sticky polymer selected from the group consisting of an olefinic elastomer and an elastic polymer.

9. A film for applying on a handrail of a conveyor according to claim 1, wherein the first sticky layer comprises at least a polyisobutylene.

10. A film for applying on a handrail of a conveyor according to claim 1, wherein the thickness of the substrate film is 50 to 3000 μm and the thickness of the first sticky layer is 0.1 to 100 μm.

11. A film for applying on a handrail of a conveyor according to claim 1, which comprises an adhesive layer comprising a soft adhesive resin and formed on a second surface of the substrate film and an ink receiving layer formed on the adhesive layer.

12. A film for applying on a handrail of a conveyor according to claim 11, wherein the Young's modulus of the ink receiving layer relative to that of the substrate film is 0.5 to 3 and the Young's modulus of the adhesive layer relative to that of the substrate film is 0.5 to 3.

13. A film for applying on a handrail of a conveyor according to claim 11, wherein the adhesive layer comprises at least one adhesive resin selected from the group consisting of a urethane-series resin and a vinyl-series polymer.

14. A film for applying on a handrail of a conveyor according to claim 11, wherein the adhesive layer comprises a polymer containing an acrylic unit.

15. A film for applying on a handrail of a conveyor according to claim 11, wherein the ink receiving layer comprises at least one selected from the group consisting of
(A1) an aqueous polymer composition which is a composition obtained by polymerizing a monomer composition containing a hydrophilic vinyl monomer and a copolymerizable vinyl monomer in an aqueous solution containing a saponified vinyl acetate-series polymer and at least one aqueous resin selected from the group consisting of an aqueous urethane resin and an aqueous polyester-series resin and
(A2) a cationic vinyl polymer having a cross-linking group.

16. A film for applying on a handrail of a conveyor according to claim 11, which further comprises a protective layer formed on the ink receiving layer.

17. A film for applying on a handrail of a conveyor according to claim 1, wherein a releasable separator is formed on the first sticky layer.

18. A film for applying on a handrail of a conveyor according to claim 1, which is capable of recording an image by an ink-jet recording system, an electrophotography recording system, a thermofusible transfer recording system, or a sublimation dye transfer recording system.

19. A process for applying a film on a handrail of a conveyor, which comprises recording an image on a film recited in claim 1 and applying the film on a handrail of a conveyor by attaching the first sticky layer to the handrail.

20. A use of a film recited in claim 1 for applying the film for applying on a handrail of a conveyor by attaching the first sticky layer of the film having a recorded image, to a handrail of a conveyor.

21. A process for forming a protective layer, which comprises recording an image on the ink receiving layer of a film recited in claim 11, applying the film on a handrail of a conveyor by attaching the first sticky layer to the handrail, and forming a protective layer on the ink receiving layer by attaching a second sticky layer to the ink receiving layer.

22. A handrail of a conveyor, on which a film recited in claim 1 is applied.
